(19) United States
(12) Patent Application Publication
(10) Pub. No.: US 2017/0023072 A1
(43) Pub. Date: Jan. 26, 2017

(54) SPRING ASSEMBLY FOR RETURNING PISTON

(71) Applicant: PIOLAX, INC., Yokohama-shi (JP)

(72) Inventor: Takeaki TANAKA, Yokohama-shi (JP)

(21) Appl. No.: 15/215,472

(22) Filed: Jul. 20, 2016

(30) Foreign Application Priority Data
Jul. 22, 2015 (JP) 2015-145122

(51) Int. Cl. F16D 25/12; F16D 13/52; F16D 13/58; F16H 63/30; F16D 25/0638

(52) U.S. Cl. CPC F16D 25/12; F16H 63/30; F16D 25/0638; F16D 13/58; F16D 13/52; F16H 2063/3093

(57) ABSTRACT

The embodiments relate to a spring assembly for returning a piston by urging the piston slidably arranged in a case in a predetermined direction. The spring assembly includes: an annular member; and plural spring members fixed to the annular member and arranged to urge the piston against the case. The annular member includes plural notch portions disposed on one of an inner periphery and an outer periphery of the annular member between the adjacent spring members, and plural standing wall portions disposed on the other one of the inner periphery and the outer periphery of the annular member opposite to the notch portions between the adjacent spring members. Each of the standing wall portions has a linear shape when viewed in a direction along a central axis passing through a center of the annular member.

### CROSS-REFERENCE TO RELATED APPLICATION(S)

This application claims priority from Japanese Patent Application No. 2015-145122 filed on Jul. 22, 2015, the entire contents of which are incorporated herein by reference.

### FIELD

The present invention relates generally to a spring assembly for returning a piston that is used for urging in a predetermined direction a piston arranged to slide in a case.

### BACKGROUND

A spring assembly for returning a piston may include an annular member and plural coil springs erected on the annular member, and is used for urging a piston arranged to slide in a case is used, for example, in an automatic transmission (hereinafter, referred to also as “AT”) in a vehicle. To be specific, plural clutches are disposed, a piston is slidably housed, and a spring assembly is disposed in a case of the AT. Thus, the piston is urged by the spring assembly in a direction away from the clutches in a normal state. When the piston is pressed against the urging force of the spring assembly by the oil pressure of hydraulic oil and abuts on the clutches, transmission power from a shaft member is transmitted. On the other hand, when the oil pressure of hydraulic oil is reduced, the piston is urged by the spring assembly to get away from the clutches, and transmission power from the shaft member is cut off.

For example, there may be provided a retainer which includes an annular metallic plate and coil springs erected from the metallic plate at predetermined intervals in the circumferential direction. Plural frame-like walls are provided at the outer peripheral edge of the above-described metallic plate so as to be erected in an arc shape along the circumferential direction. The retainer is fixed to the inside of a case having a circular shape in cross section in an AT via a snap ring. Lubricant oil for preventing seizure of a piston or a clutch flows in the case in the AT, and the lubricant oil flows also between the frame-like walls on the outer periphery of the retainer and the inner periphery of the case, and between the outer periphery of the piston and the inner periphery of the retainer (for example, see JP-2009-172616-A).

Here, if the plural frame-like walls have an arc shape so as to be adapted to the inner periphery of the case having a circular shape in cross section, the clearance may not be easily secured between the frame-like walls and the inner periphery of the case, and the lubricant oil may not smoothly flow.

### SUMMARY

The present invention provides a spring assembly for returning a piston by urging the piston slidably arranged in a case in a predetermined direction. The spring assembly includes: an annular member engaged with one of the case and the piston; and plural spring members fixed to the annular member at predetermined intervals in a circumferential direction of the annular member, and arranged to urge the piston against the case in a predetermined direction. The annular member includes plural notch portions disposed on one of an inner periphery and an outer periphery of the annular member between the spring members that are adjacent in the circumferential direction of the annular member, one of a part of the piston and a part of the case being inserted into the notch portions, and plural standing wall portions disposed on the other one of the inner periphery and the outer periphery of the annular member opposite to the notch portions between the spring members that are adjacent in the circumferential direction, each of the standing wall portions having a linear shape when viewed in a direction along a central axis passing through a center of the annular member.

The annular member may include protruding portions protruding from the other one of the inner periphery and the outer periphery of the annular member at the same side with the standing wall portions in a radial outer direction or in a radial inner direction of the annular member at positions corresponding to the spring members between the standing wall portions that are adjacent in the circumferential direction.

Each of the notch portions may include a first notch portion formed to be fitted with the one of the part of the piston and the part of the case to be inserted thereinto, and a second notch portion further notched from an inner periphery of the first notch portion. Gaps provided between the second notch portions and one of an outer periphery of the piston and an inner periphery of the case may be larger than gaps provided between the first notch portions and the one of the outer periphery of the piston and the inner periphery of the case. And, the standing wall portions may be disposed on the other one of the inner periphery and the outer periphery of the annular member at positions corresponding to the second notch portions.

According to the above-described configurations, since the standing wall portions are disposed on the outer periphery or the inner periphery of the annular member that is on the side opposite to the notch portions, have a linear shape when viewed in the direction along the central axis of the annular member, and are disposed between the spring members adjacent to each other in the circumferential direction of the annular member, the rigidity of the annular member can be secured, and the clearance between the case and the piston can be large to secure a wider passage for lubricant oil, as compared with a case where arc-shaped standing wall portions are provided. Thus, the lubricant oil can be more smoothly flown.

### BRIEF DESCRIPTION OF DRAWINGS

FIG. 1 is a perspective view of a spring assembly for returning a piston according to one embodiment.

FIG. 2 is a perspective view of the spring assembly.

FIG. 3 is an enlarged perspective view of relevant components of the spring assembly.

FIG. 4 is a plan view of the spring assembly when viewed from a central axial direction of an annular member.

FIG. 5 is a cross-sectional view of the spring assembly.

FIG. 6 is an explanatory plan view of the spring assembly that is in the state of being mounted on a piston and a case when viewed from the central axial direction of the annular member.

FIG. 7 is an explanatory cross-sectional view of the spring assembly that is in the state of being mounted on the piston and the case.

FIG. 8 is a cross-sectional view of relevant components of an automatic transmission on which the spring assembly is mounted.

FIG. 9 is a perspective view of a spring assembly for returning a piston according to another embodiment.

FIG. 10 is a perspective view of the spring assembly.

FIG. 11 is an explanatory plan view of the spring assembly that is in the state of being mounted on a piston and a case when viewed from the central axial direction of the annular member.

FIG. 12 is an explanatory cross-sectional view of the spring assembly that is in the state of being mounted on the piston and the case.

### DETAILED DESCRIPTION

A spring assembly for returning a piston according to one embodiment will be described with reference to the drawings.

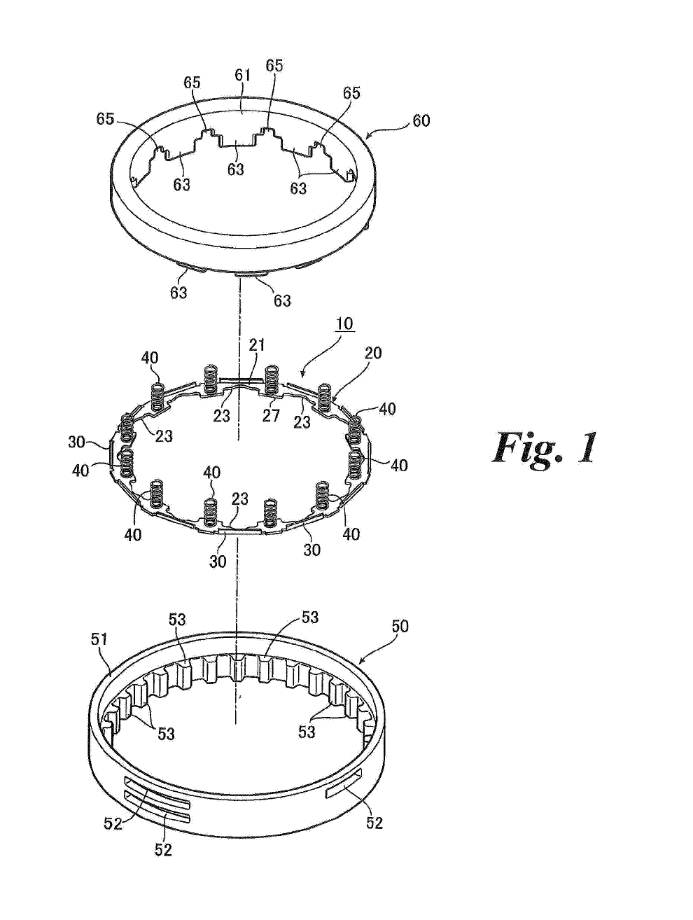

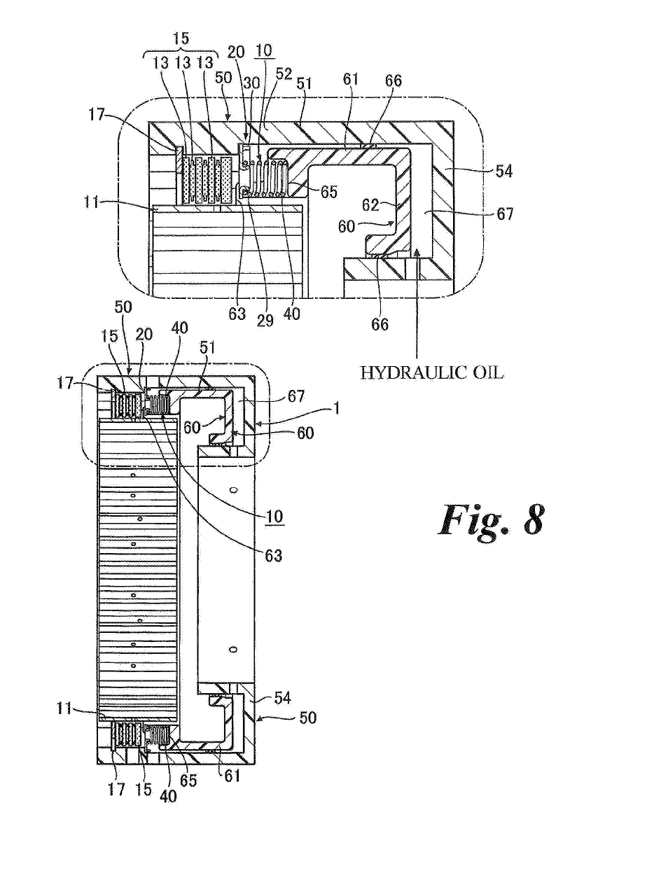

As shown in FIGS. 1 and 8, a spring assembly 10 for returning a piston according to the present embodiment (hereinafter, referred to simply as the “spring assembly 10”) is used for urging in a predetermined direction a piston 60 arranged to slide in a case 50.

The above-described case 50 and the above-described piston 60 are mounted on an automatic transmission 1 (hereinafter, referred to as the “AT 1”) as shown in FIG. 8 in the present embodiment; however, the present invention is not limited to this embodiment. The structure of the AT 1 will be described later.

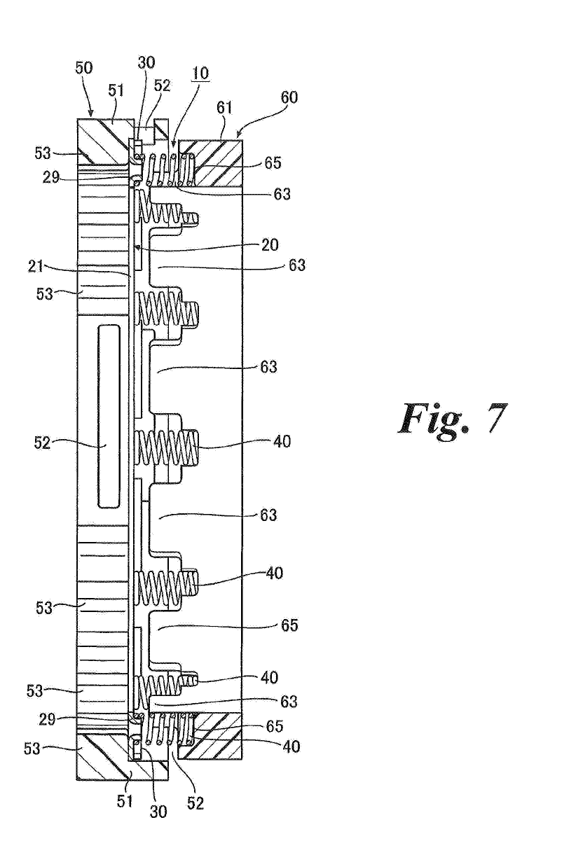

In FIGS. 1 and 7, parts of the case 50 and the piston 60 are omitted as compare with those shown in FIG. 8, for the sake of simple illustration of the relationship between them and the spring assembly 10.

As shown in FIG. 1, the above-described case 50 in the present embodiment includes a frame-like wall 51 having an annular shape. The frame-like wall 51 includes plural lubricant oil holes 52 having a predetermined width disposed along a circumferential direction of the frame-like wall 51. Plural protruding portions 53 are disposed on the inner periphery of the frame-like wall 51 at predetermined intervals in the circumferential direction so as to protrude from the positions on the inner periphery excluding the above-described lubricant oil holes 52 toward the frame-like wall center.

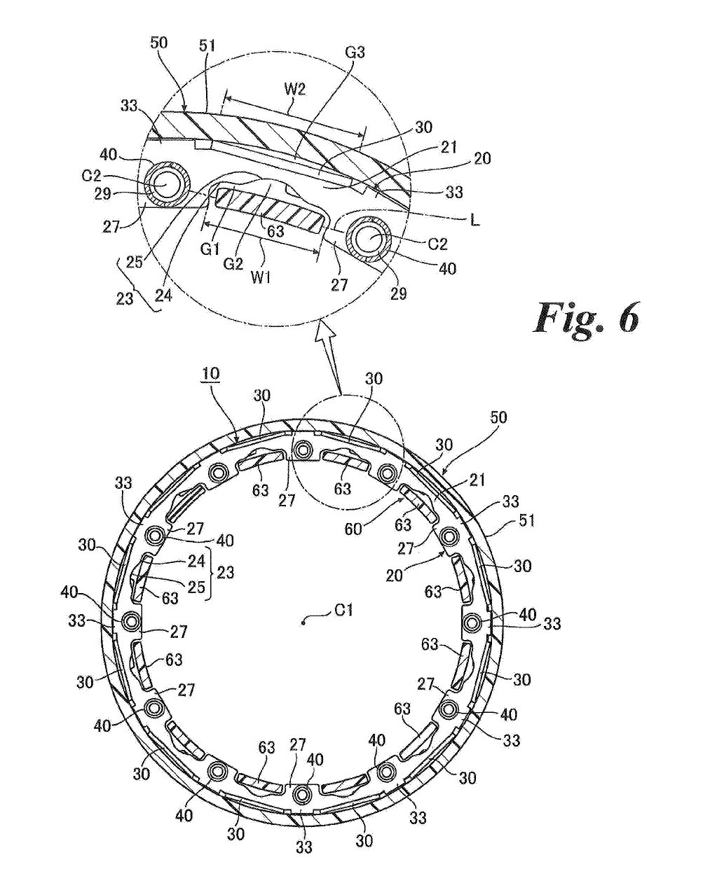

As shown in FIGS. 1 and 7, the above-described piston 60 according to the present embodiment includes an annular portion 61 having an annular shape. Plural pressing portions 63 protrude from a one end portion of the annular potion 61 in the axial direction along the shaft center of the annular potion 61 at predetermined intervals in a circumferential direction of the annular potion 61. Spring supporting concave portions 65 are disposed on the one end portion of the annular potion 61 in the axial direction between the adjacent pressing portions 63 and 63. The spring supporting concave portions 65 have a concave shape, and are arranged to support a the-other-end portion of spring members 40. The above-described pressing portions 63 define “a part of the piston” that fits with notch portions 23 to be described later of an annular member 20 that constitutes the spring assembly 10 as shown in FIG. 6.

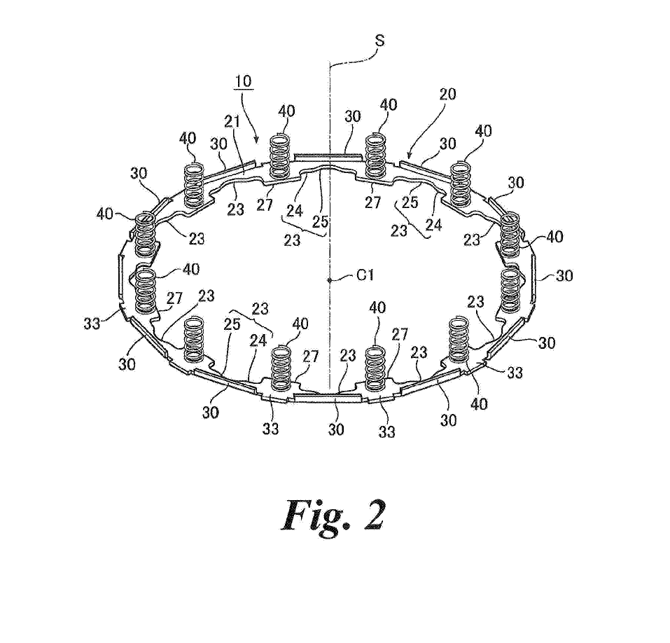

The spring assembly 10 includes the annular member 20 arranged to be engaged with the case 50, and the plural spring members 40 fixed to the annular member 20 at predetermined intervals in a circumferential direction of the annular member 20 and arranged to urge the piston 60 against the case 50 in a predetermined direction as shown in FIGS. 1 and 2. The spring members 40 in the present embodiment define coil springs formed by winding a metal wire. The spring member may be, for example, a leaf spring as long as it is capable of urging a piston, and is not specifically limited.

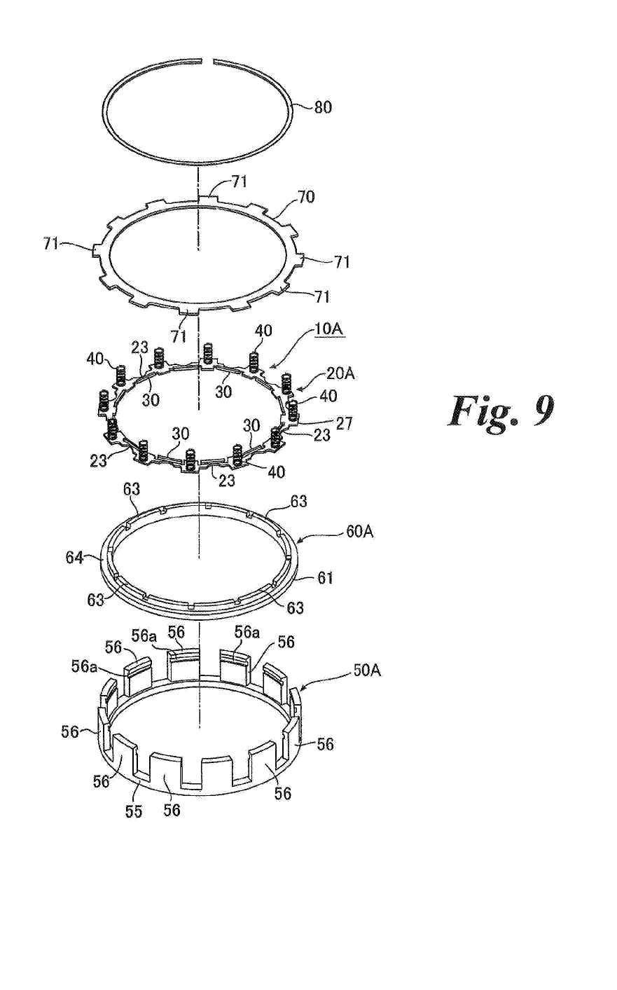

As shown in FIGS. 2, 4, and 6, the above-described annular member 20 in the present embodiment includes an annular plate 21 having an approximately annular plate shape, and the notch portions 23 into which the pressing portions 63 that define a part of the above-described piston 60 are inserted, the plural notch portions 23 being disposed on the inner periphery of the annular plate 21 at predetermined intervals along the circumferential direction of the annular plate 21 between the spring members 40 and 40 adjacent to each other in the circumferential direction of the annular member 20. “Notch portions” may be disposed on the outer periphery of an annular member as in an embodiment shown in FIGS. 9 to 12.

As shown in FIG. 6, each of the notch portions 23 in the present embodiment includes a first notch portion 24 and a second notch portion 25. The first notch portion 24 is formed by notching the inner periphery of the annular plate 21 so as to fit with each pressing portion 63 of the piston 60. The pressing portions 63 get into the first notch portions 24, respectively. The second notch portion 25 is formed by notching the inner periphery of the first notch portion 24 in the radial outer direction more deeply than each first notch portion 24 in the center of a width direction of each first notch portion 24. The pressing portions 63 do not get into the second notch portions 25. The “notch portions” may be configured without the second notch portions 25.

As shown in FIG. 6, a gap G2 between the second notch portion 25 and the outer periphery of the pressing portion 63 of the piston 60 is larger than a gap G1 between the first notch portion 24 and the outer periphery of the pressing portion 63 of the piston 60.

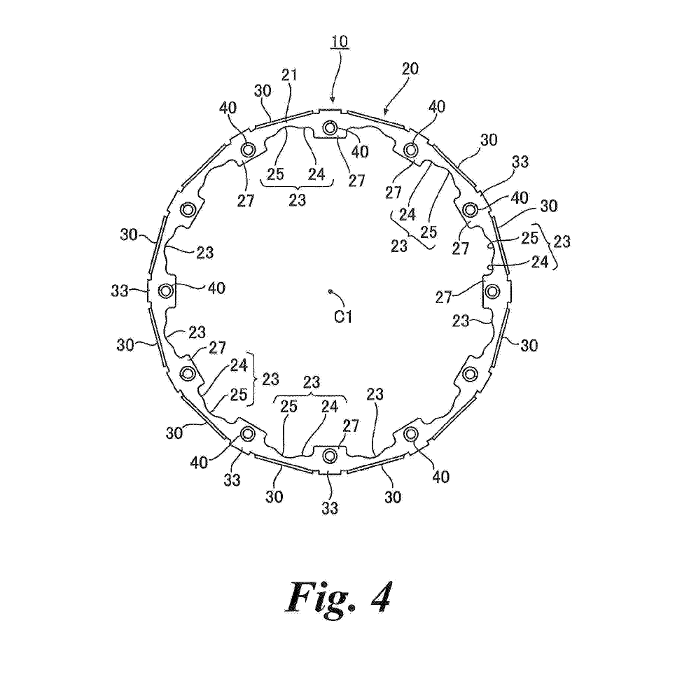

As shown in FIG. 4, protruding pieces 27 protrude in the radial inner direction of the annular plate 21 on the inner periphery of the annular plate 21 between the notch portions 23 and 23 adjacent to each other in the circumferential direction of the annular plate 21.

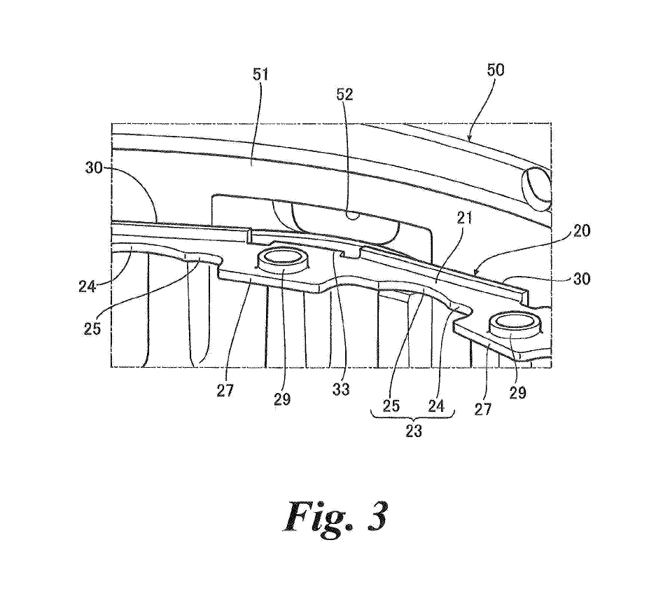

As shown in FIGS. 3, 6, and 7, cylinder portions 29 having a cylindrical shape are disposed at portions of the annular plate 21 that are closer to the inner periphery and including the protruding pieces 27. The cylinder portions 29 are inserted into one end portions of the spring members 40 to be swaged at the inside thereof with plastically deforming the cylinder portions 29. Thus, the cylinder portions 29 are engaged with the one end portions of the spring members 40, and the spring members 40 are fixed to the annular plate 21 in the state of being erected (see FIG. 7).

In the present embodiment, the plural spring members 40 are erected at predetermined intervals along the circumferential direction of the annular plate 21 (see FIGS. 2 and 4). A method for fixing the spring members 40 to the annular member 20 is not limited to the above-described “swaging”, and may be welded, adhered, or bonded using a glue or the like, which is not specifically limited.

Plural standing wall portions 30 having a rib shape are erected on the peripheral edge of the annular member 20 that is on the opposite side to the notch portions 23, that is, on the outer periphery of the annular member 21 that constitutes the annular member 20, at predetermined intervals along the circumferential direction of the annular member 21. An embodiment that standing wall portions are disposed on the inner periphery of an annular member will be described in the embodiment shown in FIGS. 9 to 12 to be described later.

As shown in FIGS. 4 and 6, the standing wall portions 30 have a linear shape when viewed in the direction along a central axis S passing through a center C1 (see FIG. 2) of the annular plate 21 that constitutes the annular member 20, and are disposed between the above-described spring members 40 and 40 fixed adjacent to each other in the circumferential direction of the annular plate 21.

As shown in FIGS. 4 and 6, the standing wall portions 30 are disposed at positions corresponding to the notch portions 23 disposed on the inner periphery of the annular plate 21. In the present embodiment, the standing wall portions 30 are disposed at positions corresponding to the second notch portions 25 especially among the notch portions 23. To be more specific, the standing wall portions 30 are disposed with their middle portions in the width directions placed at position approximately matching the second notch portions 25 (see FIG. 4).

In the present embodiment, as shown in FIG. 6, each standing wall portion 30 is approximately parallel to a line segment L connecting the centers C2 and C2 of the spring members 40 and 40 that are fixed adjacent to each other in the circumferential direction of the annular plate 21.

The standing wall portions 30 and the notch portions 23 may have a relationship as follows. As shown in FIG. 6, assuming that the width of each standing wall portion 30 is W2 and the width of the above-described notch portion 23 (the smallest width of each notch portion) is W1, the formula W2=(0.5 to 1.5)×W1 may be satisfied. More specifically, the formula W2=(0.8 to 1.2)×W1 may be satisfied.

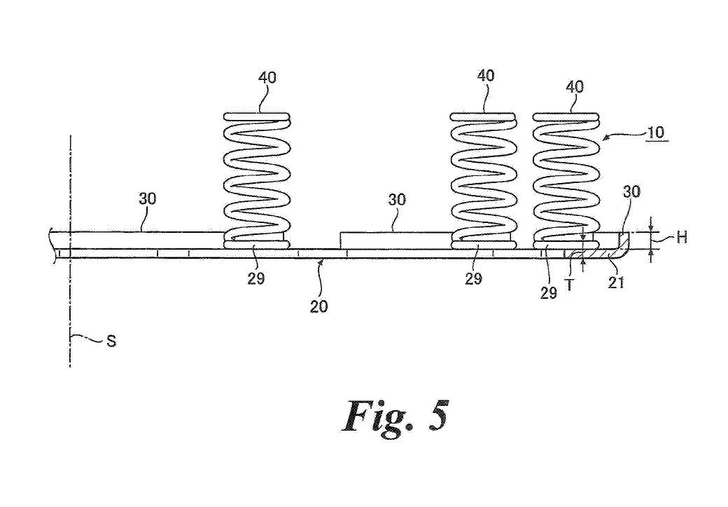

As shown in FIG. 5, the standing wall portions 30 are bent so as to be approximately vertical to the annular plate 21, that is, so as to be in a direction along the central axis S of the annular plate 21. The bending angle of the standing wall portions 30 with respect to the annular plate 21 is not specifically limited.

As shown in FIG. 5, assuming that the thickness of the annular plate 21 is T, and the height of the standing wall portions 30 from the front surface of the annular plate 21 (the face where the standing wall portions stand) is H, the formula H≧T may be satisfied. More specifically, the formula H=(1 to 2)×T may be satisfied.

As shown in FIGS. 4 and 6, the annular plate 21 includes protruding portions 33 protruding in the radial outer direction of the annular plate 21 from the outer peripheral edge of the annular plate 21 on the side of the standing wall portions 30 at positions corresponding to the above-described spring members 40 between the standing wall portions 30 and 30 adjacent to each other in the circumferential direction of the annular plate 21.

The spring assembly 10 having the above-described configuration is arranged in a predetermined position by inserting the annular member 20 into the inner periphery of the case 50 and making the face of the annular plate 21 that is opposite to the spring-erected direction abut on to be engaged with the plural protruding portions 53 of the case 50 (see FIG. 7). In this state, gaps G3 having a predetermined space are formed between the outer peripheries of the standing wall portions 30 of the spring assembly 10 and the inner periphery of the frame-like wall 51 of the case 50 as shown in FIG. 6, and the gaps G3 have a configuration such that lubricant oil flows through them.

As shown in FIGS. 1, 6, and 7, the piston 60 is disposed in the case 50 via the spring assembly 10 by inserting the other end portions of the spring members 40 into the plural spring supporting concave portions 65 of the piston 60 and arranging the plural pressing portions 63 of the piston 60 in the positions corresponding to the plural notch portions 23 of the annular plate 21. In this state, the piston 60 has a configuration as follows. When the piston 60 is pressed by the oil pressure of the hydraulic oil, the pressing portions 63 get into the first notch portions 24 of the notch portions 23 while not getting into the second notch portions 25. The gaps G1 are formed between the pressing portions 63 and the first notch portions 23, and the gaps G2 are formed also between the pressing portions 63 and the second notch portions 25. The gaps G1 and G2 also have a configuration such that lubricant oil flows through them.

The AT 1 on which the spring assembly 10 and the piston 60 are mounted has the configuration shown in FIG. 8.

The case 50 and the piston 60 are partly omitted in FIGS. 1 and 7 as described above. The above-described case 50 includes, as shown in FIG. 8, an annular wall 54 disposed on one end portion of the frame-like wall 51 extending in a predetermined length. The piston 60 also includes an annular wall 62 disposed on one end portion of the annular portion 61 extending in a predetermined length. An oil pressure chamber 67 enclosed by a seal ring 66 is formed between the annular wall 54 and the annular wall 62.

The piston 60 is disposed slidably in the above-described case 50, and a rotating element 11 of the other side on which a brake is put is disposed rotatably in the case 50. A clutch 15 including plural friction plates 13 is fixedly disposed in the rotating element 11. The clutch 15 is supported by a supporting member 17 engaged with the case 50. The piston 60 is urged in a direction away from the above-described clutch 15 by the spring assembly 10 engaged with the case 50.

When the hydraulic oil in the oil pressure chamber 67 is pressurized, the piston 60 is pressed against the urging force of the spring assembly 10, and the pressing portions 63 of the piston 60 are connected with the clutch 15. In this state, the rotative force is transmitted to the rotating element 11, and the case 50 and the rotating element 11 are rotated together. On the other hand, when the pressure applied to the hydraulic oil is reduced, the piston 60 is urged in the direction away from the clutch 15 by the urging force of the spring assembly 10, and the rotative force is not transmitted to the rotating element 11.

Next, operation and effect of the spring assembly 10 having the above-described configuration will be described.

To be specific, as shown in FIGS. 4 and 6, the spring assembly 10 includes the standing wall portions 30 that are disposed on the outer periphery of the annular plate 21 constituting the annular member 20 that is on the side opposite to the notch portions 23, have a linear shape when viewed in the direction along the central axis S (see FIG. 2) of the annular plate 21, and are disposed between the spring members 40 and 40 adjacent to each other in the circumferential direction of the annular plate 21. Thus, the rigidity of the annular member 20 can be secured by the standing wall portions 30. The clearance between the inner periphery of the case 50 and the standing wall portions 30 of the annular member 20, that is, the gaps G3 shown in FIG. 6, can be large. Thus, in a state where the spring assembly 10 is engaged with the case 50 as shown in FIG. 6, a wider passage for lubricant oil can be secured as compared with a case where standing wall portions have an arc shape. In addition, the lubricant oil can be more smoothly flown.

The standing wall portions 30 can be formed, for example, by bending the annular plate 21 of the annular member 20. The standing wall portions 30 have a linear shape when viewed in the direction along the central axis S passing through the center C1 of the annular member 20 (see FIGS. 4 and 6). Thus, the standing wall portions 30 can be more easily formed as compared with a case where standing wall portions are formed to have an arc shape. That is, the standing wall portions 30 have improved formability.

In the present embodiment, the annular plate 21 of the annular member 20 includes protruding portions 33 protruding in the radial outer direction of the annular plate 21 from the peripheral edge of the annular plate 21 on the side of the standing wall portions 30 at the positions corresponding to the above-described spring members 40 between the standing wall portions 30 and 30 adjacent to each other in the circumferential direction of the annular plate 21 as shown in FIGS. 4 and 6. Thus, in a state where the spring assembly 10 is engaged with the case 50 as shown in FIG. 6, the protruding portions 33 abut close to the inner periphery of the case 50, that is, the inner periphery of the frame-like wall 51 in the present embodiment. In addition, the spring assembly 10 can be disposed with preventing the annular member 20 from rattling with respect to the inner periphery of the case 50. Since the protruding portions 33 protrude in the radial direction of the annular member 20, the large width can be secured for portions for disposing the spring members 40. Thus, the spring members 40 can be easily fixed to the annular member 20, and the rigidity of the annular member 20 can be increased. In addition, the durability of the annular member 20 at the time of being urged by the spring members 40 can be improved.

In the present embodiment, since the annular plate 21 constituting the annular member 20 includes not only the above-described first notch portions 24 but also the second notch portions 25 that are notched more deeply than the first notch portions 24 in the radial outer direction as shown in FIGS. 4 and 6. Thus, a wider passage for lubricant oil can be secured, and the flow of the lubricant oil can be more improved. The annular plate 21 of the annular member 20 includes the standing wall portions 30 disposed at the positions corresponding to the second notch portions 25. Thus, while the annular member 20 has a narrow width because of the second notch portions 25, it can be reinforced with the standing wall portions 30 to secure sufficient rigidity. In addition, the urging force of the spring members 40 can be reliably conveyed to the piston 60.

FIGS. 9 to 12 show a spring assembly for returning a piston according to another embodiment. The same reference numerals are provided to the constituent elements that are substantially same as those in the above-described embodiment, and explanations of those constituent elements are omitted.

A spring assembly 10A for returning a piston (hereinafter, referred to simply as the “spring assembly 10A”) according to the present embodiment is different from the above-described embodiment in the positions where the notch portions 23 and the standing wall portions 30 are disposed, and the shapes of a case 50A and a piston 60A are accordingly different from the above-described embodiment.

As shown in FIG. 9, the case 50A in the present embodiment includes an annular portion 55, and plural spring supporting walls 56 erected at predetermined intervals along a circumferential direction of the annular portion 55. Plural engagement grooves 56a are provided on the inner surfaces of the spring supporting walls 56 at the distal ends in the erected direction.

The piston 60A in the present embodiment includes an annular portion 61, pressing portions 63 protruding from the inner peripheral edge of the annular portion 61 at predetermined intervals along a circumferential direction of the annular portion 61, and a step-like portion 64 disposed on an outer peripheral edge portion of the annular portion 61 and arranged to support the above-described spring assembly 10A.

In the present embodiment, a spring supporting member 70 having an annular shape arranged to support the other end portions of the spring members 40 of the spring assembly 10A is provided, and the spring supporting member 70 is arranged to be engaged with the engagement grooves 56a of the spring supporting walls 56 of the above-described case 50A. Plural spring supporting plates 71 protrude from the outer periphery of the spring supporting member 70 at predetermined intervals in a circumferential direction of the spring supporting member 70. A snap ring 80 for preventing the spring supporting member 70 from falling off the case 50A is provided.

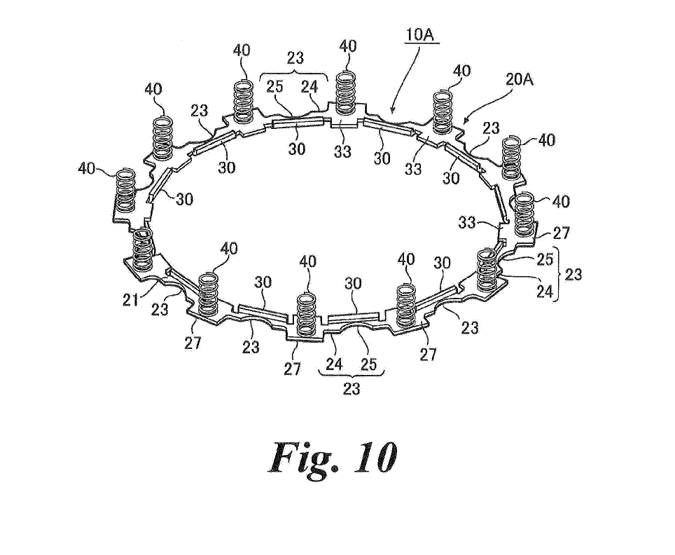

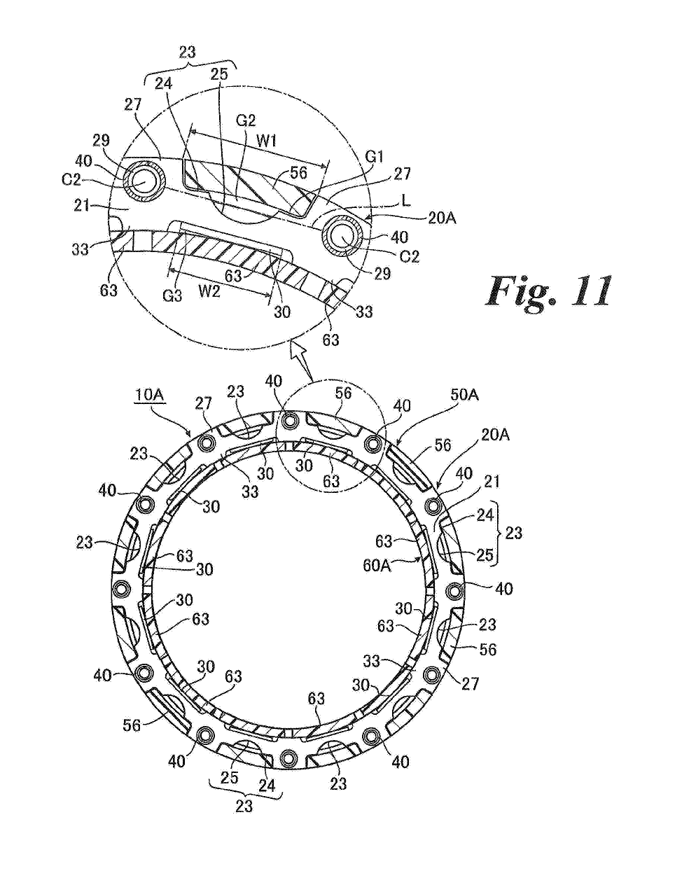

An annular member 20A in the present embodiment is arranged in a predetermined position by making the annular plate 21 supported to be engaged with the step-like portion 64 of the above-described piston 60A as shown in FIGS. 10 and 11.

The plural notch portions 23 into which the spring supporting walls 56 that define a part of the case 50A are inserted are disposed on the outer periphery of the annular plate 21 at predetermined intervals in the circumferential direction of the annular plate 21 between the spring members 40 and 40 adjacent to each other in the circumferential direction of the annular member 20A.

To be specific, the plural notch portions 23 including the first notch portions 24 arranged to fit with the spring supporting walls 56 of the case 50A and the second notch portions 25 notched more deeply than the first notch portions 24 in the radial inner direction are disposed on the outer periphery of the annular plate 21 at predetermined intervals along the circumferential direction of the annular plate 21. The spring supporting walls 56 of the above-described case 50A are arranged to get into the notch portions 23. The protruding pieces 27 protrude in radial outer direction of the annular plate 21 from the outer periphery of the annular plate 21 between the notch portions 23 and 23 adjacent to each other in the circumferential direction of the annular plate 21.

As shown in FIGS. 10 and 11, plural standing wall portions 30 having a rib shape are erected from the inner periphery of the annular member 21 of the annular member 20A that is on the opposite side to the notch portions 23 at predetermined intervals along the circumferential direction of the standing wall portions 30. The annular plate 21 includes the protruding portions 33 protruding in the radial inner direction of the annular plate 21 from the inner peripheral edge of the annular plate 21 on the side of the standing wall portions 30 at positions corresponding to the spring members 40 between the standing wall portions 30 and 30 adjacent to each other in the circumferential direction of the annular plate 21.

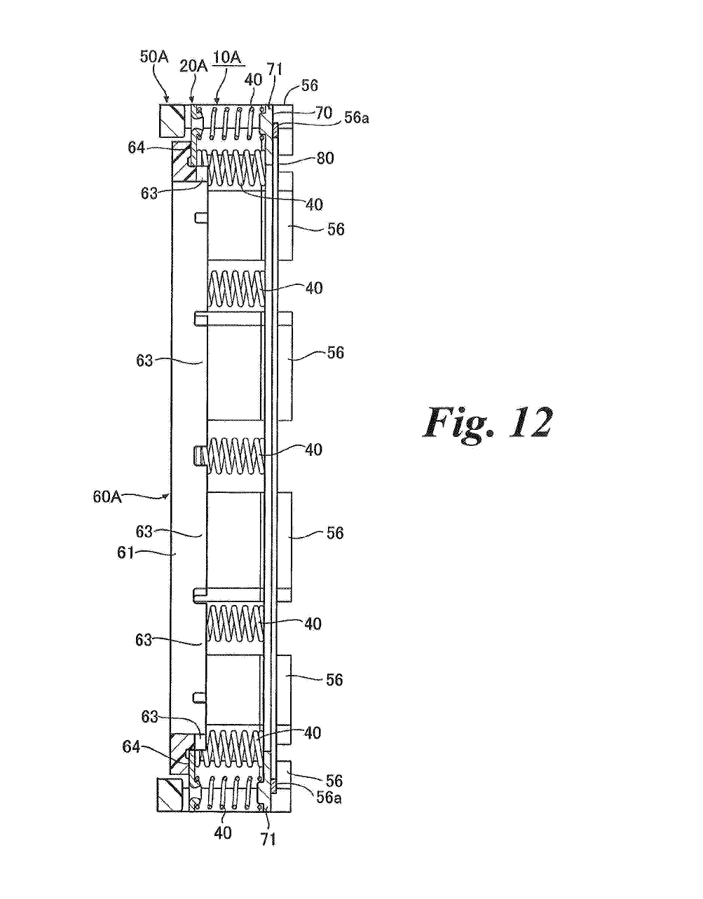

The spring assembly 10A having the above-described configuration is mounted by making the annular member 20A be supported to be engaged with the step-like portion 64 of the piston 60A while inserting the protruding pieces 27 on the outer periphery of the annular member 20A between the adjacent spring supporting walls 56 and 56 of the case 50A (see FIG. 9). The spring assembly 10A is mounted by making the other end portions of the spring members 40 fixed to the spring assembly 10A be supported by the spring supporting plates 71 of the spring supporting member 70 while inserting the spring supporting plates 71 between the adjacent spring supporting walls 56 and 56 of the case 50A. Thus, the spring supporting member 70 is retained by the snap ring 80 so as not to fall off the engagement grooves 56a of the spring supporting walls 56 of the case 50A (see FIG. 12).

In this state, as shown in FIG. 11, the pressing portions 63 of the piston 60A are disposed on the inner peripheral side of the annular plate 21 of the annular member 20A, and the gaps G3 are formed between the outer peripheries of the pressing portions 63 of the piston 60A and the inner peripheries of the standing wall portions 30 of the annular member 20A. The spring supporting walls 56 of the case 50A get into the first notch portions 24 of the annular member 20A while not getting into the second notch portions 25 to form the gaps G1 between the spring supporting walls 56 and the first notch portions 24 and to form the gaps G2 between the spring supporting walls 56 and the second notch portions 25.

In the present embodiment, the rigidity of the annular member 20A can be secured by the plural standing wall portions 30 on the inner periphery of the annular member 20A. In a state where the spring assembly 10A is engaged with the piston 60A as shown in FIG. 11, the clearance (the gaps G3) between the outer periphery of the piston 60A and the standing wall portions 30 of the annular member 20A can be larger. Thus, a wider passage for lubricant oil can be secured, and the lubricant oil can be more smoothly flown.

In a state where the spring assembly 10A is engaged with the piston 60A as shown in FIG. 11, the plural protruding portions 33 protruding in the radial inner direction of the annular member 20A abut close to the outer periphery of the piston 60A. Thus, the spring assembly 10A can be disposed with preventing the piston 60A from rattling with respect to the inner periphery of the annular member 20A.

The present invention is not limited to the embodiments described above, and it is also possible to add a variety of modifications to the embodiments. Such embodiments are also included within the scope of the present invention.

1. A spring assembly for returning a piston by urging the piston slidably arranged in a case in a predetermined direction, the spring assembly comprising:
an annular member engaged with one of the case and the piston; and
plural spring members fixed to the annular member at predetermined intervals in a circumferential direction of the annular member, and arranged to urge the piston against the case in a predetermined direction,
wherein the annular member comprises
plural notch portions disposed on one of an inner periphery and an outer periphery of the annular member between the spring members that are adjacent in the circumferential direction of the annular member, one of a part of the piston and a part of the case being inserted into the notch portions, and
plural standing wall portions disposed on the other one of the inner periphery and the outer periphery of the annular member opposite to the notch portions between the spring members that are adjacent in the circumferential direction, each of the standing wall portions having a linear shape when viewed in a direction along a central axis passing through a center of the annular member.

2. The spring assembly of claim 1,
wherein the annular member comprises protruding portions protruding from the other one of the inner periphery and the outer periphery of the annular member at the same side with the standing wall portions in a radial outer direction or in a radial inner direction of the annular member at positions corresponding to the spring members between the standing wall portions that are adjacent in the circumferential direction.

3. The spring assembly of claim 1,
wherein each of the notch portions comprises
a first notch portion formed to be fitted with the one of the part of the piston and the part of the case to be inserted thereinto, and
a second notch portion further notched from an inner periphery of the first notch portion,
wherein gaps provided between the second notch portions and one of an outer periphery of the piston and an inner periphery of the case are larger than gaps provided between the first notch portions and the one of the outer periphery of the piston and the inner periphery of the case, and
wherein the standing wall portions are disposed on the other one of the inner periphery and the outer periphery of the annular member at positions corresponding to the second notch portions.
